(19) United States
(12) Patent Application Publication
(10) Pub. No.: US 2001/0032094 A1
(43) Pub. Date: Oct. 18, 2001

(54) System and method for managing licensing information

(76) Inventors: Swarupanda Ghosh, Wilmington, DE (US); Nicholas Bachar, Wilmington, DE (US); Thomas F. Grillo, New York, NY (US); Thomas D. Molitor, Wilmington, DE (US); Thomas J. Couser, Wilmington, DE (US); Peggy A. Law, Wilmington, DE (US); Santosh Setty, Wilmington, DE (US); Edward Kelly, Wilmington, DE (US)

Correspondence Address: OSTROLENK FABER GERB & SOFFEN, 1180 AVENUE OF THE AMERICAS, NEW YORK, NY, 100368403

(21) Appl. No.: 09/758,820

(22) Filed: Jan. 11, 2001

Related U.S. Application Data
(60) Provisional application No. 60/198,939, filed on Apr. 21, 2000.

(51) Int. Cl. G06F 17/60

(52) U.S. Cl. 705/1; 705/4; 705/7; 434/109

(57) ABSTRACT

A system for indicating whether an agent or agency has met the requirements specified by a licensing entity according to criteria specified by the licensing entity. Information respecting the agent or the agency is input into the system including licensing status and status of continuing education requirements. The system can be used by entities such as banks or brokerages to verify appropriate licenses have been obtained and are maintained in force. The system can also be used to prompt agents or agencies to obtain necessary upcoming requirements for certifications. The system can be used in a multi-user environment and can be distributed across a network of computers.

This application is based on and claims benefit of provisional application number 60/198,939, filed Apr. 21, 2000, entitled LICENSING INFORMATION SYSTEM, to which a claim of priority is made.

### BACKGROUND OF THE INVENTION

1. Field of the Invention

This invention generally relates to a licensing information system and more particularly, relates to a system for tracking and maintaining information related to compliance with regulatory and licensing requirements.

2. Description of the Related Prior Art

In the increasingly competitive world of insurance service offerings, many demands are being placed on providers to offer cost effective accurate and speedy solutions to customer's needs. One area in which customer demands require a focus of business resources is in the determination of licensing of insurance agents and agencies to provide specific insurance products in various states.

Professionals in a variety of disciplines, including insurance agents, provide services under license by state, federal or other accrediting bodies. For example, insurance agents are required to be licensed in each state in which they conduct business. Generally, each state requires a license examination before issuing an insurance agent license. Certain states require a pre-licensing study course before taking the insurance licensing exam. In addition, many states have continuing education (CE) requirements which must be satisfied to maintain insurance licenses.

It is typical for insurance agents to work with a number of types of companies doing business in a wide variety of disciplines. For example, property-casualty insurance companies, life and health insurance companies, banks, broker-dealers, third party marketers and medium to large insurance agencies all rely on a body of insurance agents to meet their insurance needs. In addition, an insurance agent may only provide products authorized by an appointing carrier. An insurance carrier will generally confirm that an agent is (1) licensed and (2) appointed by the carrier to provide certain authorized products. It is a typical occurrence, for example, that a corporation, wishing to supply its needs for insurance in a given state, will contact an agent or agency that the corporation confirms is both licensed and appointed by a particular carrier in the given state.

An entity such as a bank that does a large amount of insurance business in a number of states will generally wish to keep track of whether its employee insurance agents are properly licensed in a particular state, and properly appointed by a carrier to provide products of interest within the particular state. However, it is typically very difficult to maintain and track a list of agents with current licenses in addition to their particular appointments by insurance carriers, and keep such a list updated on a regular basis. Furthermore, it is difficult to ascertain whether insurance agents for the bank have met all of the CE requirements mandated by each particular state, to ensure their licensing status is maintained.

From the viewpoint of insurance agents, it would be desirable to know when certain CE requirements are due, and how to obtain the appropriate training. In addition, if an agent wishes to do business in a number of states, the agent must meet all the requirements for each of those states. It is difficult and time consuming for an agent to obtain all the necessary information to meet the requirements of state licensing, obtain and fill out appropriate documents and file and confirm receipt of the documents from the state agencies. Preparing for and taking required examinations is also problematic with regard to time and resource requirements.

Moreover, insurance agents, insurance carriers and entities which require agent services must all have access to changes in law which may effect licensing, certification and compliance with CE requirements. Maintaining a list of agents and their current license status becomes more complicated if changes in law must be incorporated into numerous independent databases tracking groups of various agents. Insurance agencies have the further difficulty of complying with tax filing and reporting procedures.

Insurance Agencies also must maintain licenses with different States or issuing authorities to remain in business. These agencies must also be appointed by various different insurance carriers to provide services and products offered by the carriers. It is generally the case that an appointment by a given insurance carrier will involve huge volumes of data which must be properly transferred between a given agency and an appointing carrier.

At present, various portions of the information needed to track licensing requirements is provided by a few independent sources. There is no centralized system for maintaining all the necessary information. In addition, there is no centralized system that can provide agents, agencies, carriers or businesses with the requirements for obtaining licenses, certified CE provider training and other requirements, plus provide feedback from accrediting agencies on license status and effective dates.

The present invention solves these problems of the prior art by providing a centralized updated and current database that tracks all relevant information related to licensing of agents and agencies. The present invention further provides agents with information relative to their license status, and requirements for maintaining their certification. These licensing needs are common to any type of situation in which an individual or entity must be licensed by an accrediting agency, for example, doctors, lawyers or pilots.

### SUMMARY OF THE INVENTION

The present invention provides a licensing information system that can be used for tracking and maintaining all relevant information regarding a particular individual and their licensing status in addition to relevant information regarding different commercial insurance organizations. The system automatically contacts and notifies agents and agencies of upcoming licensing requirements, expiration of certifications and status of carrier appointments for particular products. Agents can also access the system to verify their present status with respect to licensing, appointments and continuing education requirements. The system enables the agent to obtain the requirements for getting a particular license, to print out forms on-line, submit a request for a license by mail and be notified within several days of whether the license has been granted. The licensing system tracks the license application and creates automatic reminders to system users or operators to inform the agent once the license has been granted. In addition, a hard copy of the license is sent to the agent within several days, again assisted by prompts within the licensing system. The hard copy of the license is used to verify entry and updates of information in the data base.

Various entities requiring insurance services can access the several databases of the present invention to verify that a particular agent meets the requirements for their needs, or to locate an agent which meets all the requirements that the particular entity has in mind. The system is designed to capture information for tracking licensing requirements for both insurance and securities businesses. The system eliminates a need for multiple source documents and other information resources. The system is a network wide on-line system with audit capabilities for comparing insurance sales to licensing/appointing requirements that will eliminate audit exceptions. In addition, the system has a document manager attachment that minimizes the need for hard copy documentation and provides printable on-line licensing forms, appointment applications and CE certificates. The system provides in a single location information previously only available from multiple sources through multiple channels. The system has on-line audit capabilities and has the capability to produce specialized financial reports. The system is accessible in a multi-user environment and is flexible to permit customization for a particular customer's need.

The system is distributable, that is, capable of being used by a number of operators or users at a number of remote locations. This system can also be interconnected with other related systems to provide information transfer capabilities. The system also has unique and extensive reporting capabilities that facilitate a display of information in a user friendly manner. It further gives the user the flexibility to build individually customized reports.

### BRIEF DESCRIPTION OF THE DRAWINGS

The above, and other objects, features and advantages of the present invention will become apparent from the following description read in conjunction with the accompany drawings, in which:

FIG. 1 is a functional schematic showing the interrelation of system components;

FIG. 2 is an illustration of interconnections between the system of FIG. 1 and external interfaces;

FIG. 3 is an illustration of the contents of the agent components;

FIG. 4 is an illustration of the contents of the agency components;

FIG. 5 is an illustration of the contents of the state requirements components;

FIG. 6 is an illustration of the contents of the system maintenance and configuration components;

FIG. 7 is an illustration of the contents of the report details components; and

FIG. 8 is an illustration of a main menu screen according to a system of the present invention.

### DETAILED DESCRIPTION OF THE PREFERRED EMBODIMENTS

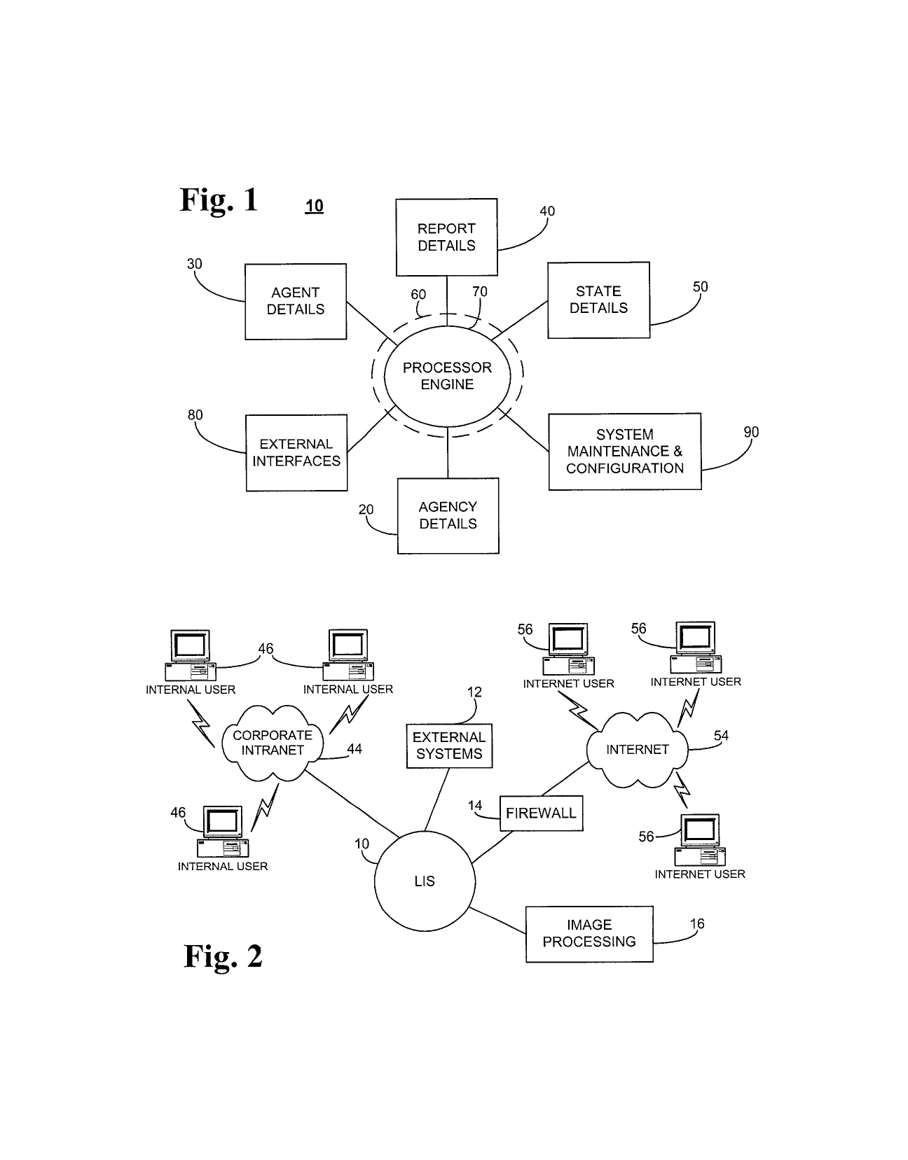

Referring now to FIG. 1, a diagram of the functional interactions of the licensing information system (LIS) 10 is shown. LIS 10 includes several system components 20-90 that have interrelated items of information concerning insurance agents and agencies. System components 20-90 are accessible on a single user or multi-user platform and can be accommodated within a database. The database functions can be made available through a RDBMS (Relational Data-Base Management System) type database, connected to a user interface. Users access system components 20-90 through requests to LIS 10, which responds with query results, reports and updated information. LIS 10 also permits updated information obtained from external systems 12 (FIG. 2) to be entered in system components 20-90. Updated information typically relates to changes in state requirements and details such as contact addresses, and CE course offerings. Users of LIS 10 include compliance officers, insurance agents, agencies, carriers and entities requiring insurance licensing and compliance services.

Users can perform searches on system components 20-90 to retrieve information about agents and agencies, such as licenses obtained, appointments given and so forth. Users such as agents and agency personnel can download documents available through LIS 10 which can be filled out and filed to meet licensing requirements. Users can also print out on-line forms which may be filled out and submitted to appropriate authorities and request updates to database information based on changed status with respect to license requirements.

Referring now to FIG. 2, the overall functional relationship between LIS 10 and various users and systems is shown. LIS 10 is accessible through a corporate intranet 44 by various internal users 46. Internal users 46 access and maintain the information contained in system components 20-90 through LIS 10. Internal users 46 do not have to be located within a corporate entity to use LIS 10, and can access LIS 10 from a remote location as well. Corporate intranet 44 is composed of various interconnected computers and telecommunications equipment under the control of a corporate entity.

In addition to internal users 46, remote access to LIS 10 is available to internet users 56 through an internet 54. A firewall 14 provides secure access to internet users 56 to permit only authorized entities to access LIS 10 through internet 54. Internet 54 is a collection of interconnected computers through which request messages and responses are passed. An internet user 56 can be located anywhere in the world as long as a connection to internet 54 is available at that location.

LIS 10 is also connected to external systems 12 through an external interface 80. External systems 12 represent a variety of sources and users of information related to licensing requirements. For instance, external systems 12 may include sales systems which must query LIS 10 to verify whether certain agents may sell particular products in a given state. Alternatively, external systems 12 may include programs related to providing CE instruction to meet state CE requirements. External systems 12 can feed CE information to LIS 10 and verify compliance requirements needed by marketing software. External systems 12 use the data provided and maintained by LIS 10 to assist in making decisions about coverage in particular geographic areas for certain products, for instance.

Also connected to LIS 10 is a system for image processing 10, which facilitates on-line reproduction of paper forms, and assists in reducing paper storage needs. Image processing 10 stores forms completed by agents, agencies, carriers or licensing institutions to retain a record of various licensing and reporting requirements.

Referring again to FIG. 1, several system components 20-90 within LIS 10 which are accessed and modified by a processor engine 70 are shown. System components 20-90 are illustrated in FIG. 1 as organized licensing details including state details 50, agency details 20, agent details 30 and report details 40. External interfaces 80 permit access to a variety of external systems 12 for gathering information relevant to agent and agency licensing. LIS 10 further includes a system maintenance and configuration component 90, which provides an administrator with security access for performing maintenance functions. Typical maintenance functions include adding or deleting users, modifying user permissions, entering or modifying records related to CE instruction and CE providers, entering or modifying state specific licensing requirements, and so forth.

Agent details 30 includes information about Agent profile, licensing status, appointment status and CE certification requirement status and other related information. The information in agent details 30 is used by LIS 10 to assure compliance with state requirements and to fill in information regarding a particular agency employing one or more agents.

Agency details 20 includes information about a particular agency such as its profile, present license status, appointments, officers and reports filed. The information in agency details 20 is used by LIS 10 to verify a match for a particular agency to provide services in a given state or in a particular area of insurance services.

State details 50 includes such details as state CE requirements, pre-licensing requirements, certified schools for providing CE and other assorted information related to licensing. The information in state details 50 is used by LIS 10 to match the status of a particular agency or agent to determine whether or not licensing requirements have been met.

Report details 40 includes functionality and information for creating reports and for printing reports related to a particular topic. Reports can be generated by LIS 10 using report details 40 for any number of types of information available in the system, including tax and licensing information. Report details 40 also includes forms suitable for use with various state institutions to meet licensing requirements, as discussed above. A set of reports in a fixed format are provided for typical reporting needs. In addition, ad-hoc reports may be created by the user to encompass individualized reporting needs. The ad-hoc reports may use any of the information in LIS 10 in various formats as the user desires.

LIS 10 further includes security features 60 to prevent unauthorized access to the system. An authorized user must be given user permissions which are verified at each screen level. All operations on information within the system are permission based. Security and permissions can be administered on a local level, with specific access granted to individuals or groups.

LIS 10 also provides a search facility for locating various records or information based on information keys. A user can search by any relevant information key such as, for example, an agent name, social security number or registration number. A search can access information within LIS 10 in an organized fashion for use with reports, for example. The results of a search can be displayed on a screen, printed or stored in a file, in addition to forming the basis of various reports.

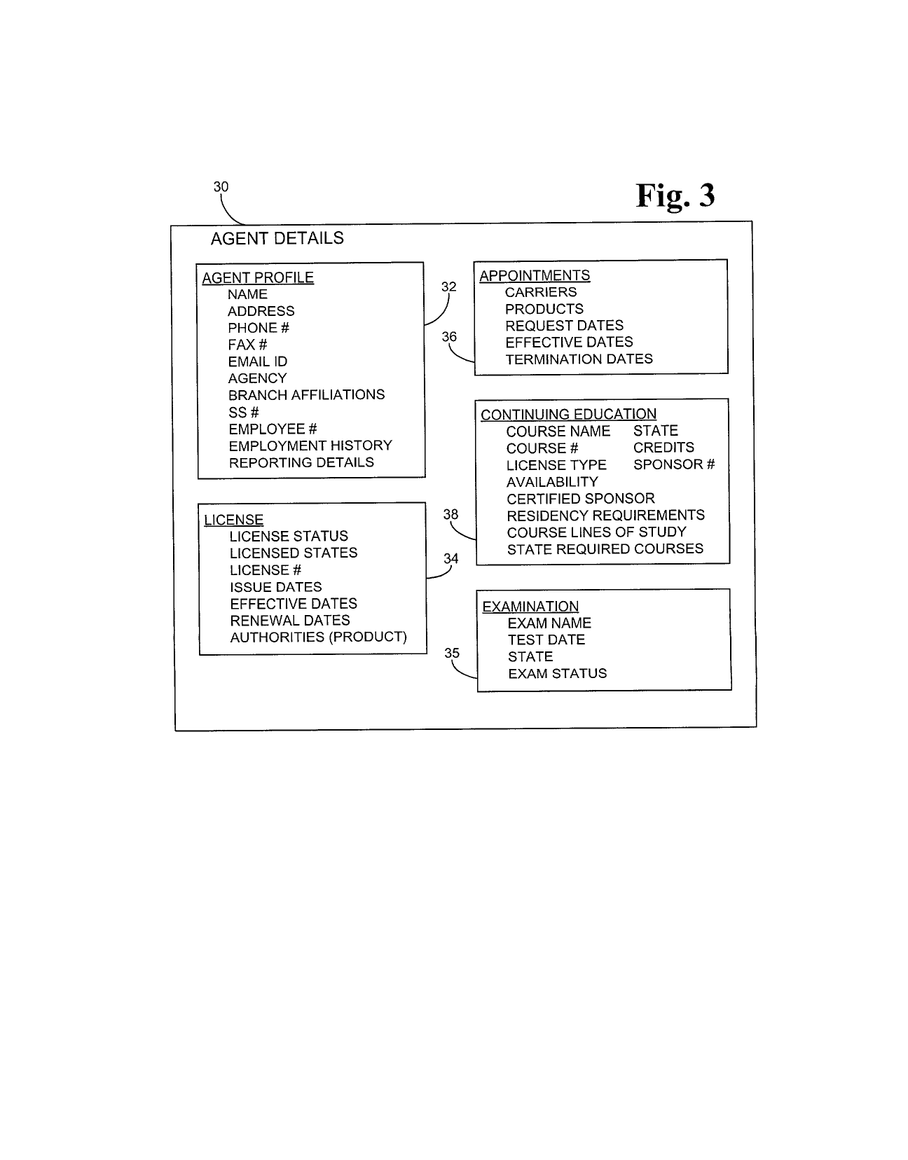

Referring now to FIG. 3, agent details 30 includes an agent profile 32. Agent profile 32 includes information about an agent such as social security number, full name, employee ID number, contact information and so forth. Since agencies may have multiple branches, agent profile 32 provides for the addition of various branches to an agent's profile in accordance with the agent's status. An agent can be looked up and referenced by profile using a social security number, name, contact information, agency and so forth. The employment history of the agent along with records of hire dates and termination dates, and any changes that occur in the agent's employment are maintained in agent profile 32. For example, it is a general requirement of most licensing institutions that any change of address for an agent be reported to the authority within a specified time frame. LIS 10 provides a facility for changing the agent's address in agent profile 32, and printing a report to send to the appropriate authority. Where address or other like changes can be made on-line with access to external systems 12 (FIG. 2), LIS 10 provides access to external system 12 to make the changes on-line. As described above, LIS 10 also provides a search facility to locate agents by various criteria in agent profile 32.

LIS 10 permits a user to view and update information regarding an agent's license in agent details 30. Agent licensing information 34 includes such items as license status, states in which the agent is licensed, license numbers, the issue date of the license, the effective date of the license, license information for any agency to which the agent belongs, agency license renewal dates and so forth. As discussed above, LIS 10 provides a search tool to locate an agent based on name, social security number, or employee number. In addition, when particular fields within agent licensing information 34 are updated, a prompt is provided to the agent comprising information or appropriate instructions for taking action

Information regarding an agent appointment is also kept among the agent details 30 information. Appointment information 36 includes different types of insurance carriers, appointment request dates, effective appointment dates, products authorized for sale by the carrier through the agent, termination date and so forth. Appointment information 36 is updated according to changes within the appointment, for example, if the carrier offers new products. Again, capability is built into this portion of agent details 30 to permit searches by relevant appointment information. In addition, a message is automatically generated to be sent to the agent stating the information regarding an appointment.

Agent CE information 38 is also tracked in agent details 30. CE information 38 lists the CE completed by an agent and includes such items as the course name, the course number, sponsor for the class, sponsor number, the state for which the course was completed, the credits achieved and so forth. LIS 10 displays the courses taken and the requirements satisfied by the courses. By tracking the courses taken, LIS 10 is able to determine, for example, whether two consecutive cycles of the same course have been taken, which is generally considered impermissible to meet CE requirements. Notification to the agent of the requirements already met and those which are further required can be produced by LIS 10.

The licensing examination information for an agent is maintained by LIS 10 in examination details 35. Details about agent examinations include exams taken as identified by a specific name, the date on which an examination was taken, the state for which examination was made, the status of all examinations for a given agent, and so forth. LIS 10 provides various responses and notification when information in examination details is changed, as described below.

An agent can be licensed to deal in securities as well as offer insurance services. This licensing information is included in agent details 30 (not shown). The detail information with respect to securities includes all the exams that were taken by an agent to meet securities requirements and dates of examination and status of results approved. Again, the states in which the securities licenses have been granted are accessible with LIS 10.

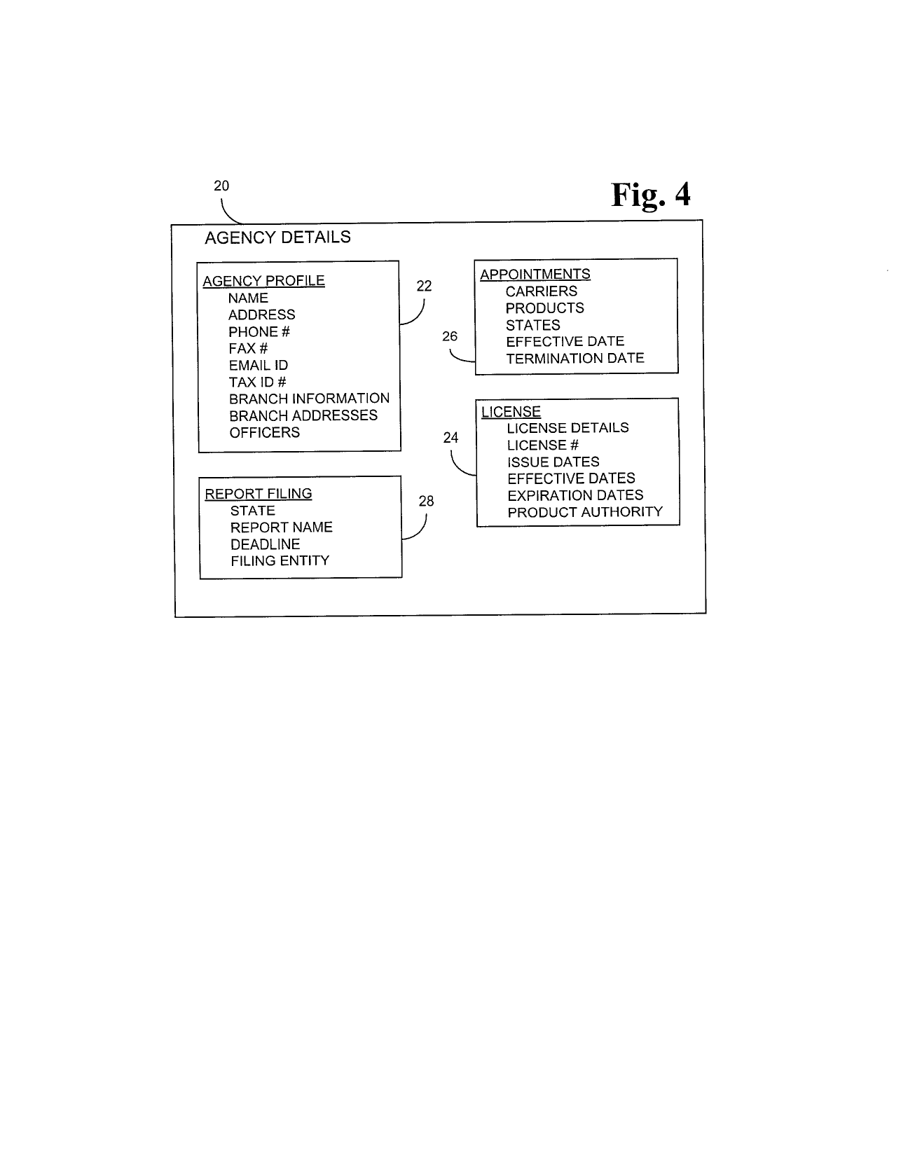

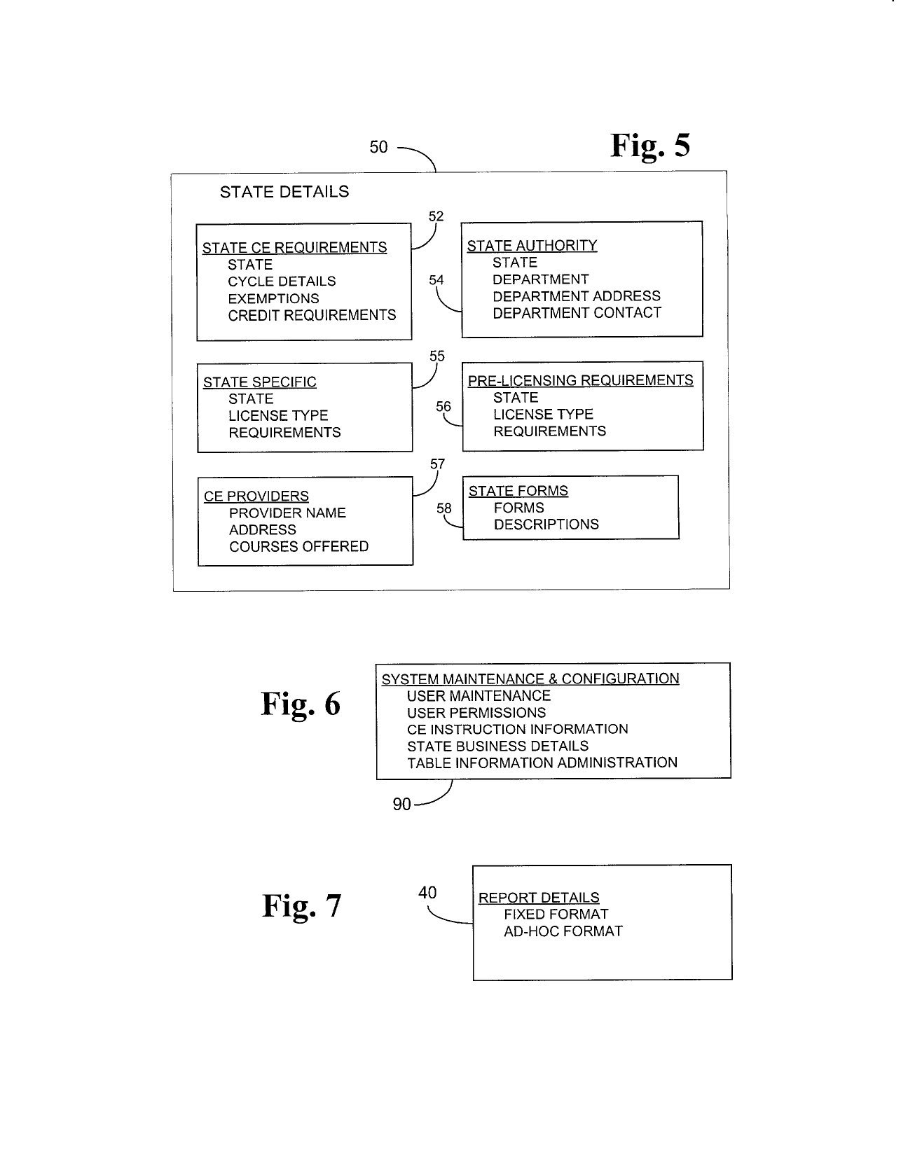

Referring now to FIG. 4, agency details 20 includes an agency profile 22. Agency profile 22 includes such items as the agency name, address, tax ID, contact information and the like. Agency profile 22 also includes the different agency branch information, including branch addresses and the like. The various officers of the agency and their relevant information, such as contact information, is also listed in agency profile 22.

The information contained in agency profile 22 permits an agency search by entry of information related to the agency such as the agency name. Agency profile 22 is also capable of reacting to changes in information related to agency details 20. For example, when a license expiration date is input into the system, an automatic reminder is generated and sent to the agency at given intervals to prompt a renewal application.

Similarly to agent appointment information 36, agency appointment information 26 is maintained in a database accessible by LIS 10. Appointment information 26 includes the insurance carriers which the agency represents, the states in which the agency operates, agency information regarding the representative agents, the products which the agency is permitted to offer, and so forth. The effective dates of appointments and their termination dates are also included in appointment information 26. Searches on agency appointment information 26 may be conducted to return information on a particular agency or group of agencies, derived from agency details 20. Again, updates to agency appointment information can initiate appropriate prompts or notices according to reminders or actions which are required.

Agency details 20 further includes agency license information 24 which contains details about the agency's license, license number, effective dates for licensing, including officer licenses, and expiration dates of agency licenses are available. Information about the products which the various agents are authorized to offer, agency state residency information, tax filing information and license detail information is also accessible.

State reporting requirements for agencies are met by extracting data regarding the agency through a search or query, and automatically or manually populating forms with relevant extracted data. Data regarding the forms to be filed is found in report filing details 28, which includes the state receiving the filing, the filing report name, the deadline for filing the report, which entity is making the report filing, and so forth. Once completed, the forms can be printed and filed with the state. In addition, blank forms can be printed and filled out manually and filed with the state to meet reporting requirements.

State details 50 includes information related to state licensing requirements for various states. This information includes such items related to a state authority 54 as department addresses and contacts to which correspondence within a state are sent. State CE requirements 52, pre-licensing requirements 56 and CE providers 57 that provide CE instruction are also maintained within state details 50. State details 50 also includes provisions for accessing state specific information 55, which involves requirements and license types specific to a given state. Also available in state details 50 are state forms 58 which are again state specific and are available to be filled out and printed for submission to comply with state requirements.

The effective dates of CE requirements, course credit requirements, term length and expiration dates are collected and tracked in state CE information 52. As discussed below, the parameters for state CE requirements 52 are entered and updated in system maintenance and configuration 90 (FIG. 6).

Requirements that are specific to particular states are recorded in state specific details 55. State specific details 55 includes such items as types of licenses permitted by a particular state, and the requirements specific to a particular state for obtaining and maintaining a license. One such group of state specific details 55 is pre-licensing requirements 56, which is not found in all states. Pre-licensing requirements 56 are not only specific to a particular state, but also to the type of license being obtained. The details of the requirements for states mandating pre-licensing activities are found in pre-licensing requirements 56. Other requirements for licenses which are particular to a state can include examination particulars, local and corporation requirements for agencies, local residency requirements for agents and agencies, disclosures by agencies and so forth. State forms 58 provides users with state specific forms for needed for various submissions and compliance requirements.

CE providers 57 that are certified by the various states are also described in state details 50. The courses of instruction offered by CE providers 57 are maintained as discussed below, and a listing of provider names, their addresses and so forth are available for access through LIS 10.

Referring to FIG. 6, LIS 10 includes a facility for system maintenance and configuration 90 which permits LIS 10 to be updated as changes occur in state requirements or in such items as CE courses offered by certified providers. LIS 10 includes a facility for collecting and tracking CE requirements for various states as the requirements are updated through system maintenance and configuration 90. Each of the items in state details 50 are updated according to changes in agency information or as laws or regulations may be modified and promulgated by state or federal authorities.

Referring now to FIGS. 1 and 7, report details 40 contains information regarding the generation of reports for various purposes. For example, reports are available based on agents, licenses, agency reporting requirements, appointment details, CE requirements and so forth. Queries to the database containing information related to agents, licenses and the like may be made based on information keys, as discussed above. In addition to a number of standard report formats for reporting regular items, LIS 10 permits the user to customize reports to choose the information they wish to have elicited, and can generate these reports automatically based on selected criteria. Report details 40 maintains these ad-hoc reports and can provide reports required by government agencies for maintaining, for instance, licenses, accreditation, agency compliance with tax reporting, and so forth. When LIS 10 is used among various branches of an agency, for example, report details 40 can be used to generate branch information required by the agency in a particular format. Similarly, an insurance carrier may require various reports from appointed agencies, the content of which the carrier can control through report details 40.

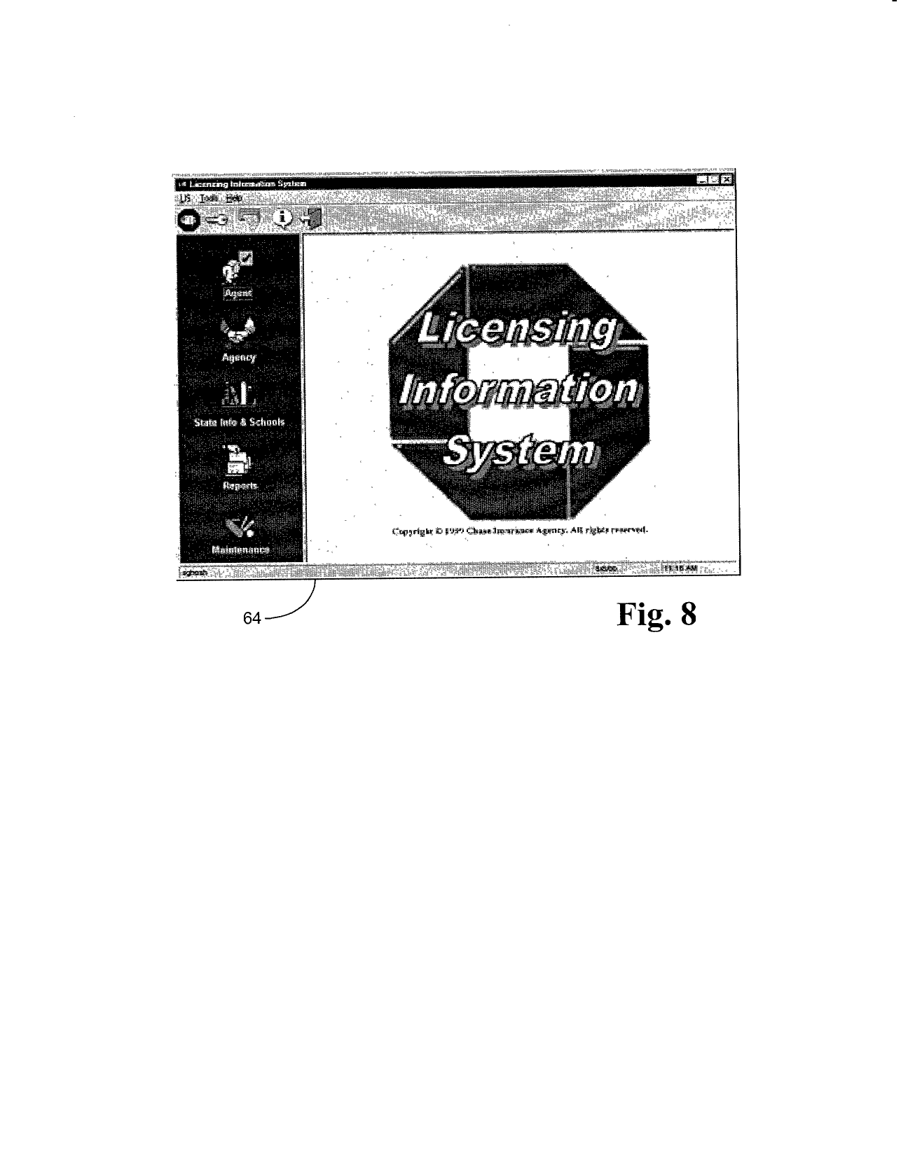

Referring now to FIG. 8, a user screen 64 for LIS 10 operates on a flexible and user-friendly basis to provide an ergonomic interface. Agent, agency, state, CE and report information is available at user screen 64 through intuitive graphical symbols and labels. For example, an agent profile 32 is accessible by selecting “Agent” at user screen 64 and instituting a search by first or last name, social security number or employee ID. The user can select and edit agent profile 32, or add an entirely new profile. Once the user has access to agent profile 32, the various fields of agent profile 32 are then available for editing or data entry.

The operation of LIS 10 is designed to be simple and intuitive, while facilitating access to complete information which meets the needs of the insurance and securities agent/licensing community. LIS 10 permits simple and complete access to information needed by agents, agencies and insurance carriers, while providing licensing requirements criteria derived from state agencies and CE providers. A particular user, whether an agent, agency owner, insurance carrier or an entity needing insurance services, can access LIS 10 to obtain information necessary to meet the needs of their particular business. Operation of LIS 10 and the interoperation of the various components of the system according to the present invention are described below.

LIS 10 reacts to entry or modification of information in agent details 30 or agency details 20 by analyzing the changes and initiating proactive measures designed to contribute to keeping agent and agency licenses current. Modifications to the information in agent details 30 or agency details 20 may be requested by an agent upon a change in status by e-mail, postal mail, or automatically by receipt of a notification from a licensing authority, such as a state insurance department. Updates the information in the various system components 20-90 can be set to be activated immediately, whereby any reports or queries conducted after the update will reflect any changes made.

Several of system components 20-90 are reactive to changes made to the data each of the components contains. As is discussed below, updates to the system information which causes changes in particular data items will initiate a section of executable code which provides a response to the change. Responses can include prompting the user for entry of an amount of money for a check request after notification of positive exam results. As dates change with progressing time, agents facing expiration dates or renewal requirements will be notified in response to a calculated date differential of, for example, 60 days before an expiration deadline. A change in state licensing requirements may provoke a notification to any agent licensed in that particular state. The following operations of the various components of LIS 10 are all capable of responding to modifications in the system data in the fashion described above.

LIS 10 permits a user to access agent profile 32 to obtain particular information related to an agent or group of agents. The user may, depending upon security permissions, search for agents based on specific criteria, select one or more agents from the search results, view complete agent profiles and compose reports based on the search results. The user may also update agent profile 32 with changes, add or delete agent information or profiles,

Agent license information 34 is accessible with a search by first or last name, social security number or employee ID. A user selects agent details 30 for searching and enters the desired information to locate a particular agent, or group of agents Once an agent or group of agents is located in the search results, the appropriate records may be selected and updated, or new records may be added to agent license information 34. LIS 10 permits the user to enter data about the agent's license or update the data based on new information.

An update to a field with relevant license information causes various actions to occur for agent license information 34. For example, if information is entered which requires a fee in response, e.g. passing a licensing exam, a prompt to request a check is automatically generated. If the user accepts the prompt, a document is automatically displayed for the user to enter a check amount.

If an agent's license is due for renewal, LIS 10 sends a prompt, or reminder, by various methods, including e-mail. The date used to generate the prompt is the license expiration date, for example. The prompt or reminder is sent at intervals until a response is obtained, for example at 60 and 30 days before expiration. If no response is obtained, or a state license does lapse, the agent is notified by various methods, including e-mail that they are no longer entitled to do business within that particular state. The event of a lapsed license is recorded in LIS 10 to make the system information current, and to provide proper results for a search or query based on, for instance, all lapsed licenses.

An agent's appointment information 36 is similarly searchable through agent profile 32 by name, social security number or employee ID. The various agent appointments are viewed, edited, updated and added in appointment information 36 as appropriate. Once an appointment becomes effective, based on entry of items such as dates, carriers and products, the system automatically notifies the agent by e-mail or other media.

An agent's CE history is accessible from CE information 38 through a search from a main screen by name or social security number or employee ID number. Agent CE information 38 is selectable for viewing, editing or reporting purposes through a CE details screen (not shown). The CE classes taken by an agent, or group of agents, are recorded and updated to provide a record which permits a comparison against state CE requirements. LIS 10 can generate a report to an agent, group of agents, agency or state licensing authority, for example, showing the CE requirements a particular agent or group of agents have already met, or further require. When LIS 10 determines that an agent must receive further CE instruction to meet the licensing requirements of the jurisdiction(s) in which the agent is licensed, LIS 10 notifies the agent and provides them with schedules of CE offerings by certified CE providers. LIS 10 further informs the agent wishing to obtain additional licenses of the licensing requirements in the desired jurisdictions and provides the agent contact and scheduling information for appropriate CE providers.

An agent's securities exam and license details (not shown) are manipulated in the same way as insurance license information 34, and include information regarding agent CE requirements. Navigation to an agent's security and license details is effected through a search screen listing an agent name, social security number or employee ID number. The exam and license information related to securities is viewed, edited or added for a particular agent through LIS 10. Again, an agent search from a main screen based on name, social security number or employee ID number is used to find a particular agent's securities exam and license information.

General information related to agency details 20 is accessed by a search from a main screen using criteria such as agency name, a particular abbreviation, or a tax ID. The search facility can locate one or more agency profiles 22 matching the search criteria and return the results to the user. Once accessed, the resulting agency profiles 22 located by the search of agency details 20 can be selected, e.g., for viewing or reporting, or modified, or information may be added or deleted, including an entire agency record, through LIS 10.

Agency license information 24 is also locatable using name, abbreviation or tax ID criteria. As with the general information in agency details 20, agency license information 24, once located, can be selected for viewing or reporting, edited or updated, and license information may be added or deleted based on changes or needs related to agency licenses. Specific agency appointments are also available through a search on name, abbreviation or tax ID for an agency. Again, agency appointment information 26 is accessible from a main screen by a search, and is selected, edited, added or deleted once located through LIS 10.

The officers of an agency are locatable by a search based on name or social security number criteria. Details related to an agency officer are again selectable, modifiable or can be added or deleted. Because the officers of an agency are generally licensed through a state insurance or securities licensing authority, they will be listed as insurance or securities agents in agent details 30. License and other general information regarding the officers may thus be accessed through an agent search as described above. In addition, if the officer's information is accessed through an agent search, their data may be updated through the above described agent information interface.

Insurance agencies generally have responsibilities related to information reporting which involves filing reports with a state insurance authority. LIS 10 provides agency filing forms which are viewed in the form of a report, and contain fields for filing dates, due dates, franchise report send/sent dates, annual reports and unclaimed property reports and other data requested by the state authority. The fields are added or deleted, viewed and edited using a form generation tool available in LIS 10. When an agency has several branches, the forms can accommodate information from the several branches for submission to the state as a single unit.

State CE requirements are accessed on an appropriately named screen, and include requirements specific to various state authorities. A user can view the various state CE requirements through LIS 10 and obtain reports or printouts of the requirements. LIS 10 compares an agent's or group of agents' fulfilled CE requirements with those required by a state to meet licensing criteria. Agents that lack particular CE training required by a state for which a license will be obtained or maintained are notified automatically, through any regular media including mail and e-mail. LIS 10 can also send to the agent or agents a current list of CE providers that are certified by the state to facilitate meeting any outstanding CE requirements. As updates to the requirements promulgated by an individual state are released, LIS 10 is modified to reflect the changes. Changes in state CE requirements or certified providers of CE instruction will prompt LIS 10 to inform agents affected by the changes of the new requirements and provide the agents with ways in which the new requirements may be met. For example, LIS 10 can inform agents about certified CE providers and instruction schedules to permit the agents to met the new requirements.

In addition to CE requirements, LIS 10 tracks other state specific requirements for licensing. For example, some states have pre-licensing requirements that can include instruction on life and health (L/H) insurance issues, exemptions, property and casualty (P/C) issues and variable life/annuity requirements. Typically, these state specific requirements must be fulfilled prior to taking a licensing examination, or are involved in the CE instruction process. LIS 10 provides agents with these state specific requirements and notifies agents when specific criteria must be met, or alternatively, when agents have met certain state specific criteria.

Information on requirements for licensing from various state authorities is accessible through LIS 10, and can be viewed, printed or incorporated into reports for use with notifications to agents, agencies, insurance carriers or the like. LIS 10 collects and tracks changes to state requirement information, and informs appropriate individuals or entities about applicable requirements and actions which must be taken to satisfy new standards. For example, an agent may be notified of a newly introduced requirement for CE instruction, together with information on the certified CE providers that offer courses satisfying the requirement. As another example, a change in the insurance law for a particular state which affects agent licensing can provoke notices to all agents listed in agent details 30 that are licensed in that state.

State insurance department information also includes contact information to obtain information from a state authority. LIS 10 tracks changes to contact information for various department functions, and uses the contact information to provide agents and agencies with appropriate addresses and contact points. Documents needing addresses or contacts can be automatically filled in using the above contact information, to provide agents or agencies with prepared document for filing in response to state requirements.

LIS 10 produces a number of reports based on data available from report details 40. Reports can be generated upon user request or set for automatic activation, for example, on a monthly basis for financial information. Once generated, the reports are used to apprise individuals or agencies of information which should be updated, or for which action may be taken. For instance, a report can be setup to automatically report upcoming license renewal requirements. Such a report may be generated to a particular agent, or obtained at a centralized agency, for example, and distributed to agents at various branches.

Reports in LIS 10 are also available to satisfy agent and agency reporting requirements. Report details 40 can contain form reports which are populated with data through a query to the updated system components 20-90. At a user command, or if set for automatic generation, reports are created for submission to appropriate state authorities to satisfy various requirements. Requirements which may be met by submission of these reports can include tax filing statements, state residency and corporation reporting laws, and issues related to the insurance or securities industry mandated by local and federal authorities. Each of these reports can be updated with information as rules or laws change, or in response to changes in agent details 30 or agency details 20.

A facility within LIS 10 permits a user to create ad-hoc reports using a report creation tool, which can draw on report forms already used within the system. For example, a user can take a report for specifying expiration dates of agent licenses or appointments, and create a new report using a portion or all of the elements of the existing reports. Reports may also be created from scratch using the report creation tool. Reports can have fields which are tied to information contained in system components 20-90, so that an changes in system information, occurring as a result of an update, for example, are reflected in later generated reports. The various parts of a report, such as tables of information, can be populated with information resulting from a search or query conducted on the various system components 20-90. Because LIS 10 can exist in a distributed form on a local or wide area network, reports can draw information from a variety of sources related to areas of functionality. For example, financial information can be coupled with licensing information and CE requirements to advise a decision on obtaining CE instruction within a budget.

Referring again to FIG. 2, LIS 10 is portable among various platforms, and can be interconnected with other systems having or requesting related information. For example, LIS 10 permits information sharing with banking or financial centers and certified CE providers. In addition, a facility for communicating through e-mail or other messaging schemes is available through internet 54. Interconnection with other systems through internet 54 or other communication means facilitates on-line application, information sharing and direct communications with an agent or agency.

LIS 10 is constructed as an object oriented type program, to facilitate modular flexibility. In addition, security features 60 mentioned previously can be accommodated within an object oriented system to derive flexible and resilient security between modules and tasks. User permissions can be based on access to objects, for instance, rather than based solely on screen level access.

LIS 10 is flexible in that it can be operated as a stand alone program, or it can be used on a network accessible by any number of computers as illustrated in FIG. 2. For example, the system can reside on a single information server, and be accessible to multiple internal users 46 through corporate intranet 44. In addition, the system can be set up to be distributed across a number of computers connected to corporate intranet 44. LIS 10 can also be implemented as a distributed system on internet 54, and accessible by a multitude of internet users 56.

LIS 10 is designed to be user friendly and simple to use, while containing all the information needed for a particular entity to meet its insurance services needs. LIS 10 further includes capabilities for image processing 16 to assist in decreasing space needed for paper storage. The system is expandable to include a number of facets available for a wide range of users. If a particular user wishes to use only a small part of LIS 10, a system enabled only for those needs can be implemented. For example, an agent may wish only to keep track of his own personal licensing requirements, and be updated with CE requirements and changing license status. A system can be implemented through LIS 10 to provide for the present needs of the agent, while having greater functionality that can be enabled as the scope of the agents need broadens.

It should be understood by those skilled in the art that the present invention is not limited to an insurance licensing system alone, but can be used in any type of situation in which an accrediting agency maintains requirements for license certification. For instance, doctors, accountants, lawyers, pilots and contractors all have licensing requirements which must be completed on a regular basis. An association requiring the services of licensed pilots, for example, may need to confirm pilot certifications and examinations. The present system can accommodate any type of regularly required licensing certificate for professions such as those mentioned.

It should be further understood that while the present invention contemplates obtaining information from a licensing authority and entering that information into the system of the present invention, further efficiencies are readily available. For example, the invention contemplates automatic interaction with a licensing authority to obtain results of examinations and changes in licensing or CE requirements without the need for human intervention. Similarly, the invention contemplates providing a licensing authority with verification of compliance with applicable state laws and regulations. These types of efficiencies are generally available according to the present invention, but are not realizable due to lack of corresponding availability from counterpart state licensing authorities.

Although the present invention has been described in connection with the plurality of preferred embodiments thereof, many other variations and modifications will now become apparent to those skilled in the art. It is preferred, therefore, that the present invention be limited not by the specific disclosure herein, but only by the appended claims.

What is claimed is:

1. A system for managing licensing information, comprising:
a source of licensing requirements information, said licensing requirements information including at least information related to obtaining and maintaining a license;
a licensee database containing licensee information, said licensee information including information related to at least one licensee capable of holding the license; and
a processor coupled to said licensee database, said processor operable to input information into said licensee database, operable to modify information in said licensee database and operable to retrieve information from said licensee database, according to criteria in said licensing requirements information

2. A licensing information system according to claim 1, wherein said licensing requirements information further comprises examinations for obtaining said license.

3. A licensing information system according to claim 1, wherein said licensing requirements information further comprises continuing education for maintaining said license.

4. A licensing information system according to claim 1, wherein said licensing requirements information is further comprised of information from at least one state entity responsible for administering licensing requirements.

5. A licensing information system according to claim 1, wherein said licensee information further includes information related to licensee appointments by a product supplier.

6. A licensing information system according to claim 1, wherein said at least one licensee further comprises an insurance agent.

7. A licensing information system according to claim 1, wherein said at least one licensee further comprises an insurance agency.

8. A licensing information system according to claim 1, further comprising said processor operable to locate portions of said licensee information matching a criteria.

9. A licensing information system according to claim 1, further comprising:
said processor operable to compare said licensee information with said licensing requirements information; and
a comparison result indicates differences between said licensee information and said licensing requirements information.

10. A licensing information system according to claim 9, further comprising an automatic notification to said at least one licensee related to at least one difference between said licensee information and said licensing requirements information indicated by said comparison result.

11. A licensing information system according to claim 1, further comprising a licensee agency database, said licensee agency database containing licensee agency information, said licensee agency information including information related to at least one licensee agency.

12. A licensing information system according to claim 1, further comprising a report database containing report information, the report information including information related to at least one of reports and responsive forms.

13. A licensing information system according to claim 1, further comprising:
said processor connectable to a worldwide network of interconnected computers;
a set of permissions capable of providing access authorization to users of said worldwide network; and
said processor permits access to said licensee database based on said set of permissions.

14. A licensing information system according to claim 1, further comprising:
said processor connectable to an enterprise network of interconnected computers;
a set of permissions capable of providing access authorization to users of said enterprise network; and
said processor permits access to said licensee database based on said set of permissions.

15. A licensing information system according to claim 1, further comprising:
a communication interface capable of accessing at least one state entity responsible for administering licensing information; and
said processor is connectable to said interface thereby permitting information to be exchanged between said licensing information system and said at least one state entity.

16. A licensing information system according to claim 1, further comprising:
a certified continuing education provider database containing education provider information, said education provider information including at least information related to continuing education courses and continuing education requirements satisfied by the continuing education courses; and
said certified continuing education provider database is coupled to said processor.

17. A computer display operable to display said licensee information under control of said processor according to claim 1.

18. A method of managing licensing information, comprising:
obtaining licensing requirements information from a licensing authority, the licensing requirements information being related to licensing requirements for at least one of obtaining and maintaining a license;
accessing a database comprising entity information related to whether at least one entity fulfills said licensing requirements;
comparing said licensing requirements to said entity information to produce a comparison result; and
determining an extent to which said comparison result indicates satisfaction of said licensing requirements by said at least one entity.

19. A method of managing licensing information according to claim 18, further comprising:
identifying actions required by said at least one entity to at least one of obtain and maintain a license;
prompting said at least one entity to take said required action.

20. A method of managing licensing information according to claim 18, further comprising:
providing required forms to said at least one entity;
submitting to said licensing authority said required forms made out by said at least one entity; and
updating said status based on said submission to said licensing authority.

21. A method of managing licensing information according to claim 18, wherein said prompting is accomplished automatically based on a change in said status.

22. A method of managing licensing information according to claim 18, wherein said licensing requirements information further comprises license examination information.

23. A method of managing licensing information according to claim 18, wherein said licensing requirements information further comprises continuing education requirements for maintaining a license.

24. A method of managing licensing information according to claim 18, wherein said at least one entity is an insurance agent.

25. A method of managing licensing information according to claim 18, wherein said at least one entity is an insurance agency.

26. A method of managing licensing information according to claim 18, further comprising:
inputting said entity information into said entity information database;
modifying said entity information in said entity information database;
retrieving said entity information from said entity information database; and
viewing said entity information in said entity information database.

27. A method of managing licensing information according to claim 18, wherein said obtaining licensing requirements further comprises obtaining continuing education provider information, the continuing education provider information including continuing education curriculum information.

28. A method of managing licensing information according to claim 18, further comprising searching said entity information database to retrieve entity information related to at least one of a specified status and a specified entity information.

29. A method of managing licensing information according to claim 18, further comprising a status of said at least one entity, said status being representative of whether said at least one entity satisfies said licensing requirements.

30. A method of managing licensing information according to claim 29, further comprising notifying said at least one entity of at least one of said status, a change in said status and upcoming requirements for obtaining or maintaining said license.

31. A method of managing licensing information according to claim 18, further comprising providing materials usable by said at least one entity to satisfy said licensing requirements.

32. A computer readable media containing a computer executable program code, wherein execution of said program code realizes said method according to claim 18.

33. A processor operable to execute a program code, wherein execution of said program code on said processor realizes said method according to claim 18.

34. A method for determining compliance with license requirements, comprising:
obtaining licensing requirements information from a licensing authority, said licensing requirements information being related to licensing requirements for at least one of obtaining and maintaining a license;
organizing licensee information related to at least one licensee;
organizing status information related to a status of at least one licensee license; and
determining from a comparison between said status information and said licensing requirements information whether said at least one licensee is in compliance with said licensing requirements.

35. A method for determining compliance with license requirements according to claim 34, further comprising searching for licensees in compliance with said licensing requirements based on said determination.

36. A method for determining compliance with license requirements according to claim 34, further comprising notifying said at least one licensee of at least one of said status, a change in said status and upcoming licensing requirements.
